(19) United States
(12) Patent Application Publication
(10) Pub. No.: US 2007/0058645 A1
(43) Pub. Date: Mar. 15, 2007

(54) Network controlled customer service gateway for facilitating multimedia services over a common network

(75) Inventors: Anoop Nannra, Orleans (CA); Andrew Timms, Ottawa (CA); Hasler Hayes, Munster Hamlet (CA); John Watkins, Ottawa (CA)

Correspondence Address: WITHROW & TERRANOVA, P.L.L.C., P.O. BOX 1287, CARY, NC, 27512, US

(73) Assignee: NORTEL NETWORKS LIMITED, St. Laurent (CA)

(21) Appl. No.: 11/200,603

(22) Filed: Aug. 10, 2005

(51) Int. Cl. H04L 12/56

(52) U.S. Cl. 370/401

(57) ABSTRACT

The present invention provides a customer service gateway acting as an interface between various customer premise equipment for a customer and a local access network. The customer service gateway has one or more customer agents and network agents. A network agent is a secure and trusted agent of the service providers, and is not accessible by the customer or the customer premise equipment for manipulation. The customer service gateway may support different types of services using different types of media from the different service providers. In operation, the service providers may sent applications to a network agent, which will run the applications to implement functions to monitor or control services or service flows for the services. The monitoring and control functions may be used to implement various types of service or service flow analysis, as well as any type of tagging, characterization, or processing of the service flows.

### FIELD OF THE INVENTION

The present invention relates to communications, and in particular to a technique for controlling services in a multi-service environment supported by one or more access networks.

### BACKGROUND OF THE INVENTION

Traditionally, dedicated access networks have been used to provide dedicated services. For example, cable networks would provide television services, telephone networks would provide telephone services, and data networks would provide data services. With the rapid acceptance and expansion of packet-based technologies, there is a movement toward providing disparate services over a common packet network. The goal is to allow multiple application service providers to connect to subscribers over one or more access networks operated by one or more network service providers. Applications can by any mixture of real time, near real time, and low priority applications, which may require any level of trustworthiness or security mechanisms.

While significant progress has been made toward providing core networks capable of transporting packets for various services, access networks connecting to a subscriber's residence or place of business are still relatively separate. Although data services may be overlaid on telephony access networks, these access networks are not configured to support a wide range of simultaneous services such as telephony, video and multimedia. Further, there is little control over the various types of media provided via the data services.

As these media services mature, there will be a need to support voice, audio, video, and other real-time or streaming applications where timely delivery of packets is important, over a common access network. Any access network providing a connection to the subscriber premises is likely to have finite bandwidth with respect to the number of services that are available and contending for that finite bandwidth. Given the movement to provide multiple services over a single access network and the different quality of service requirements associated with these services, there is a need for a technique to control the allocation of bandwidth for services and assure that subscribers are not allowed access to bandwidth or services to which they are not entitled. Given that different types of services often require various types of policing and control, there is a need for a technique to provide additional traffic control, monitoring, and processing functions at the customer premises to fully support the different service types. Further, since multiple service providers can provide services over the common access network, there is a further need for a technique to allow different service providers to provide services and have their services controlled in a desired manner. In essence, there is a need to provide control and policing on a service-by-service basis over a common access network for different types of services from different service providers in an efficient and effective manner.

### SUMMARY OF THE INVENTION

The present invention provides a customer service gateway acting as an interface between various customer premise equipment for a customer and one or more local access networks, which leads to one or more service provider networks. The customer service gateway has one or more customer agents and one or more network agents. A network agent is a secure and trusted agent of the service providers, and is not accessible for manipulation by the customer or the customer premise equipment. The customer service gateway may support different types of services using different types of media from the different service providers. In operation, the service providers may send applications to a network agent, which will run the applications to implement functions to monitor or control services or service flows for the services. The monitoring and control functions may be used to implement various types of service, or service flow analysis, as well as any type of tagging, characterization, or processing of the service flows. Other functions may be provided to the customer agent by the customer or through the network agent by the service providers, wherein the customer agent will run the applications to implement select functions for the services or service flows.

The customer agent and network agent may operate on incoming or outgoing service flows, as well as provide overall service control. The service providers may also provide policy criteria to the network agent as well as to the customer agent, wherein the agents will operate to enforce appropriate policies when implementing the services and supporting the service flows, to ensure that the services are provided having a desired quality of service and that only authorized services are provided in an appropriate fashion.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a block representation of a communication environment according to one embodiment of the present invention.

FIG. 2 is a logical representation of a customer service gateway according to one embodiment of the present invention.

FIGS. 3A-3C represent an exemplary communication flow according to one embodiment of the present invention wherein a digital rights management function is implemented at the customer service gateway.

FIG. 4 is a block representation of a customer service gateway according to one embodiment of the present invention.

FIG. 5 is a block representation of a network service edge according to one embodiment of the present invention.

FIG. 6 is a block representation of a network policy server according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

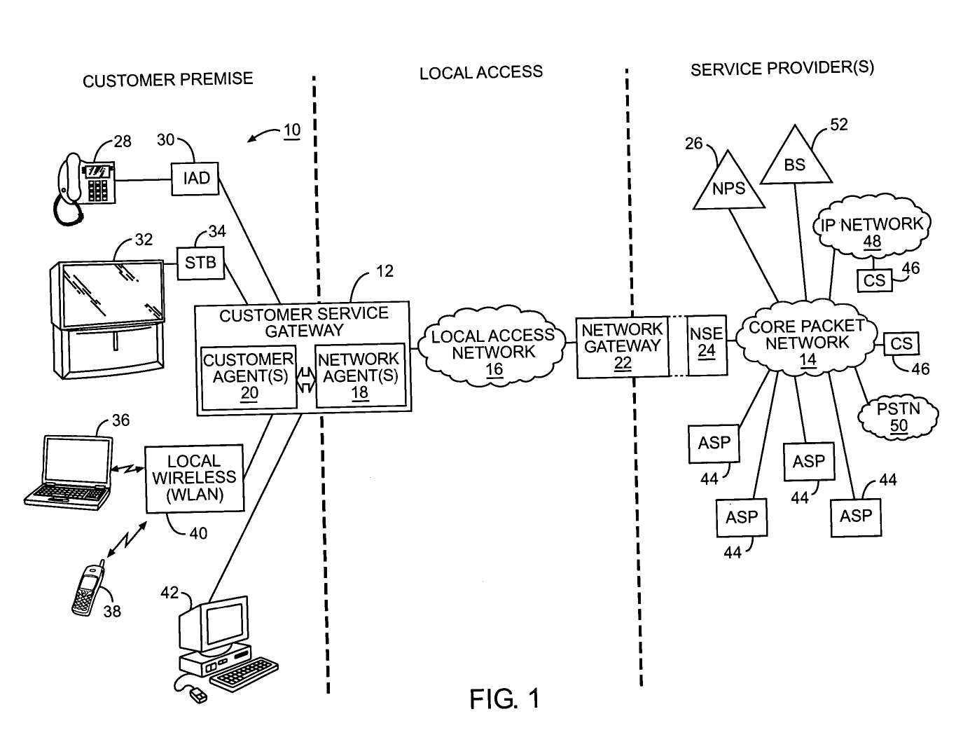

With reference to FIG. 1, a communication environment according to one embodiment of the present invention is illustrated. The communication environment may include various types of customer premise equipment (CPE)

10. The CPEs 10 are associated with a customer service gateway 12 to receive packet-based services from a core packet network 14 via a local access network 16. Depending on configuration, the customer service gateway 12 may include one or more network agents 18 and one or more customer agents 20, which cooperate to support various types of services from different service providers. The network agent 18 is a secured and trusted agent under the control of the service provider, while the customer agent is an unsecured agent, which may operate under the control of the customer as well as the service provider. In general, the network agent 18 is not accessible by the customer or CPEs 10.

The network agent 18 provides a logical interface to the local access network 16 and supports secure functions, which monitor or control service flows according to various policies of the service providers. Service flow control may include, but is not limited to, controlling the individual service, prioritizing traffic and service flows, as well as actually processing traffic in the service flows. The policies are provided to ensure that only authorized services are allowed and that content for the services is properly received at the appropriate CPE 10. As such, the present invention provides an efficient and effective monitoring and control for various services at a central point, the customer service gateway 12, where coherent and consistent policy enforcement can be applied for a customer using the appropriate policies of the service providers. The functions may be part of applications that are received from the various service providers and that run on the network agent 18. The functions include, but are not limited to, authorizing services, characterizing service flows, prioritizing services or services flows, reordering packets within service flows, routing packets, tagging service flows for subsequent processing, encrypting and decrypting service flows, compressing and decompressing service flows, converting between protocols, and any other monitoring control function deemed desirable at the customer premises.

Different services may be associated with different service providers. The present invention allows different service providers to establish secure and trusted control of the network agent 18. The functions provided by the network agent 18 may be used to support television, telephone, and high-speed internet access; support pay-per-view or other pay-per-use services; implement digital rights management, including termination and encryption for audio and video streams; control firewall operation, including opening and closing ports from the network side; provide network control for Network Address Translation (NAT); provide secure interfaces for utility meter reading; provide location validation for people on the customer premises, such as in home arrest and curfew control; or provide medical instrument telemetry and alarms for home health care. Any of these or other functions may be provided over a common network along with other services and service flows, using different encryption and decryption, over the same local access network 16. In prior implementations, separate secure networks were required to provide a trusted service.

The customer agent 20 provides a logical interface for the CPEs 10 and can run applications provided by the customer or the service providers. The applications and functions provided thereby can be controlled or modified by the customer within limits provided by the service providers. Control messaging and service flows may pass through the customer agent 20 and the network agent 18, wherein either agent can provide various monitoring and control functions. Those functions provided by the customer agent 20 are potentially customizable by the customer, while functions provided by the network agent 18 are secure and controlled solely by appropriate service providers. The customer will not have access to or control of the network agent 18.

With continued reference to FIG. 1, a network gateway 22 may be provided between a network service edge (NSE) 24 and the local access network 16. The NSE 24 cooperates with the network gateway 22 to provide an interface between the local access network 16 and the core packet network 14. For services provided to the CPEs 10 via the local access network 16, the customer service gateway 12 and the NSE 24 will operate to establish virtual communication pipes over the local access network 16 for each of the services provided to the CPEs 10. In essence, the virtual communication pipes are virtual paths having defined parameters that are sufficient to support the traffic flow, in either direction, associated with a particular service.

The network agent 18 of the customer service gateway 12 and the NSE 24 operates under the control of a network policy server (NPS) 26, which essentially instructs the network agent 18 and the NSE 24 to establish the virtual communication pipes for selected services and control the traffic flows therein. The network agent 18 and NSE 24 will cooperate to allocate resources and ensure a desired quality of service, along with providing control or shaping of traffic flow for the service. Depending on the available bandwidth and the number of services implemented, the network agent 18 and NSE 24 may also provide packet queuing and make decisions on prioritizing packets based on the parameters associated with each service.

In one embodiment, different types of services may be supported over different virtual communication pipes to various ones of the CPEs 10. The CPEs 10 may take many forms and support various types of services, such as circuit-switched or packet-based telephony, television, data, audio, and video. Various types of CPE 10 are represented in FIG. 1, but those skilled in the art will recognize that the invention is not limited to the illustrated embodiments. The CPE 10 may take the form of a telephony terminal 28, which is associated with the customer service gateway 12 via an integrated access device (IAD) 30, which effectively performs voice over packet-to-Plain Old Telephone System (POTS) adaptation. For television service, a television 32 may be supported by a set top box (STB) 34, which cooperates with the customer service gateway 12 to facilitate television service. A notebook computer or PDA 36, as well as a mobile terminal 38 may facilitate local wireless communications via a local wireless access point 40, which may facilitate local wireless communications using Wireless Local Area Network (WLAN), Bluetooth, or other local wireless technology. A personal computer 42 may also be logically associated with the customer service gateway 12 to facilitate various types of media services, including streaming audio, video, and voice, along with traditional data services. Other types of devices, such a location and medical monitoring equipment (not shown) may be provided as CPE 10.

For any of the varied services capable of being provided to the CPEs 10, the network agent 18, customer service gateway 12, and NSE 24 will function to allocate bandwidth for the virtual communication pipe and control the traffic flow for the service, other services, and their respective virtual communication pipes, to ensure that each service is delivered with an appropriate quality of service, as well as preventing unauthorized use of any resource either at the core, at any service provider, or at any CPE device.

In operation, the NPS 26 will have access to information bearing on the services that a particular subscriber is authorized to use. The information controlling access to these services is generally referred to as a user policy, which will have various parameters defining the resources that are either necessary or authorized to be used to facilitate the service. The NPS 26 will also keep track of the overall resources available through the local access network 16 as well as the services being implemented at any given time. As such, the NPS 26 will recognize which resources are being used and which resources are available for new services. Based on this information, intelligent decisions can be made to ensure that a requested service can be fulfilled. The NPS 26 illustrated represents a primary policy server for a primary service provider. The present invention allows alternate service provides (ASPs) 44 to provide services along with the primary service provider via the customer service gateway 12.

In general, the services are provided in unidirectional or bi-directional communication flows with the CPE 10 over the local access network 16, wherein the packet flows are controlled in the downstream direction (toward the CPE 10) by the NSE 24, and controlled in the upstream direction (from the CPE 10) by the network agent 18 of the customer service gateway 12. The traffic flows, which ride on top of the packet flows, may be controlled in part by service controllers (SCs, which are not shown), which may interact with the CPE 10 to facilitate the transmission of packets between the CPE 10 and a content server (CS) 46. In general, the service controllers will cooperate with the content servers 46, and perhaps with the CPE 10, to facilitate the delivery of content to effect a service over one of the virtual communication pipes. Alternatively, the services may be provided by other service provider entities or other entities provided in an associated Internet Protocol (IP) network 48 or the Public Switched Telephone Network (PSTN) 50, which may be coupled to the core packet network 14 via an appropriate gateway (not shown).

To establish service flows for a given service, the NPS 26 may instruct the customer service gateway 12 and NSE 24 to establish a virtual communication pipe for a requested service. Once the virtual communication pipe is established, the service controllers will communicate with the appropriate content server 46, and perhaps the affected CPE 10, to facilitate packet delivery for the requested service. If the requested service is high-definition television content, the content server 46 delivers a high-definition television program over an appropriately configured virtual communication pipe to the television 32 via the set top box 34. The customer service gateway 12 and NSE 24 ensure that the content is delivered with a required quality of service, and ensure that other services do not interfere with the high-definition television content. The NPS 26 controls the customer service gateway 12 and NSE 24 to ensure that the services do not conflict. To prevent such conflict, a requested service may be denied if there is insufficient bandwidth or other resources to provide the service; quality of service levels may be adjusted, if authorized, to accommodate the multiple services; or a service may be eliminated according to a defined priority profile.

In one embodiment of the present invention, the various services may be accounted for in different manners, such that telephone services are billed at a different rate than television or data services. In this instance, various ones of the NSE 24, NPS 26, service controller, or content server 46 may facilitate accounting or billing, and may generate billing information or send sufficient information to a billing server (BS) 52 to effect billing for the particular services. Depending on the implementation of the services, each service may be accounted for on a per-service basis, such as pay-per-view television, or a service may be provided on a limited basis for a monthly fee wherein additional features may include additional charges.

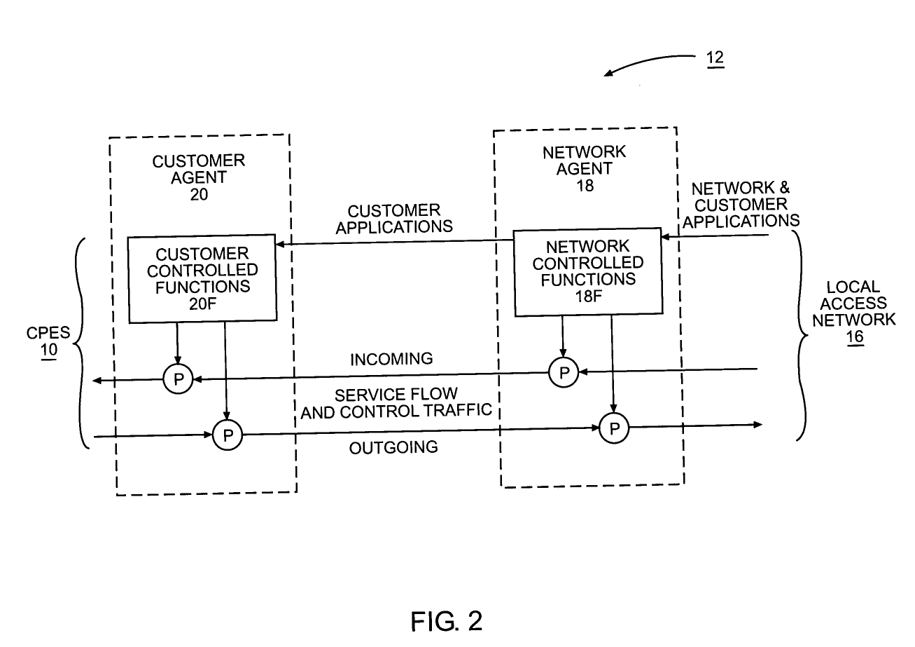

With reference to FIG. 2, a logical representation of a customer service gateway 12 is provided. As noted, the customer service gateway 12 will include a customer agent 20 and a network agent 18. The information passed through the customer service gateway 12 is categorized as either control or service flow traffic, which is supported by packet-based communications. Accordingly, outgoing service flow traffic will flow from the CPEs 10 through the customer agent 20 and network agent 18 toward a desired destination via the local access network 16. Incoming service flow traffic will flow into the CPEs 10 from the local access network 16 via the customer agent 20 and the network agent 18. The incoming and outgoing control traffic will flow in similar fashion.

In addition to facilitating service flow and control traffic, network and customer applications may be provided to the network agent 18 from the various service providers, including both primary and alternate service providers 44. These network and customer applications, when run on the respective network agent 18 and customer agent 20, will provide network controlled functions 18F and customer controlled functions 20F. In essence, the network agent 18 may receive network and customer applications, and run the network applications and forward the customer applications to the customer agent 20. The customer applications may be modified to allow the customer to gain access to and otherwise control operation of the customer applications to provide various customized functions. The network applications will reside solely in the network agent 18, will be secure with respect to the service providers, and will not be accessible by the customer or CPEs 10.

When running network applications, the network agent 18 will implement the network controlled functions 18F on the incoming and outgoing service flow and control traffic, as necessary. The network controlled functions 18F will generally relate to monitoring or control of the one or more service flows and control traffic. Such monitoring and control is generally referred to as processing (P), wherein different monitoring and control functions may be provided for different applications and different services. Accordingly, either the service flow traffic or the control traffic may be monitored or controlled for a particular application.

Similarly, the customer controlled functions 20F may be implemented on the incoming or outgoing service flow control traffic. The functions will generally include monitoring or control, which are again generally referred to as processing (P). From this illustration, it is apparent that secure applications may be downloaded to the network agent 18 and run in a trusted fashion to implement network controlled functions 18F. Customer applications, provided from the service providers or by the customer, can run on the customer agent 20 to provide customer controlled functions 20F, which may be altered, modified, or controlled by the customer without influencing the network controlled functions 18F or allowing the customer access to the network controlled functions 18F.

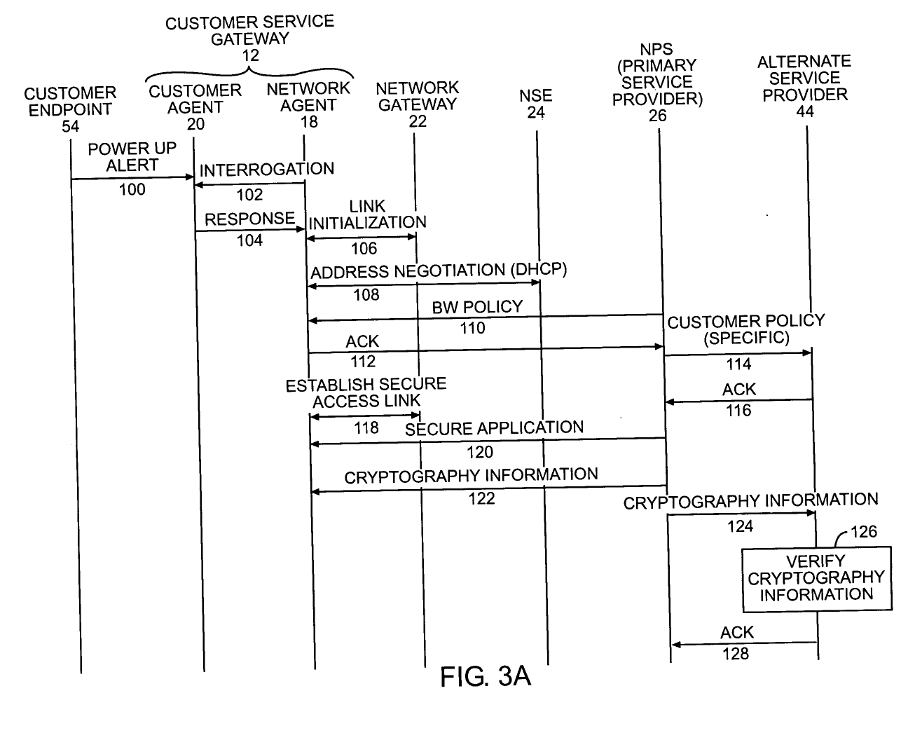

Turning now to FIGS. 3A-3C, an exemplary communication flow is provided for implementing digital rights management (DRM) according to one embodiment of the preset invention. Assume that a service requiring DRM is requested by a generic customer endpoint 54, and that the service is provided by an alternate service provider 44. The NPS 26 is associated with a primary service provider, which is primarily responsible for providing fundamental resources and control to the customer premises. When the customer endpoint 54 is turned on, a power up alert is sent to the customer agent 20 of the customer service gateway 12 (step 100). The customer agent 20 will be interrogated by the network agent 18 to obtain basic start up and initialization information regarding the customer endpoint 54 (step 102). The customer agent 20 will provide the requested information in a response sent to the network agent 18 (step 104), which will negotiate with the network gateway 22 to facilitate initialization of the communication link that will be established between the customer service gateway 12 and the network gateway 22 over the local access network 16 (step 106).

Next, the network agent 18, which may communicate using the Internet Protocol (IP), will cooperate with the NSE 24 to facilitate address negotiation, perhaps by using the Dynamic Host Configuration Protocol (DHCP), assuming addressing is not pre-provisioned (step 108). Either upon request or on a periodic basis, the NPS 26, which is associated with a service provider, will download a basic bandwidth (BW) and resource policy to the network agent 18 (step 110), which will acknowledge receipt of the policy (step 112). The NPS 26 will also provide specific customer policy information to any appropriate alternate service providers 44 (step 114), which will acknowledge receipt of the specific customer policy information (step 116). Meanwhile, the network agent 18 and the network gateway 22 will cooperate to establish a secure access link for the communication link established through the local access network 16 (step 118).

Next, the NPS 26 will send one or more secure applications to the network agent 18 (step 120). The secure applications may be any applications that the primary service provider needs to run in a secure and trusted fashion on the network agent 18 of the customer service gateway 12. One or more of the secure applications may relate to implementing DRM from the primary service provider or by the alternate service providers 44. Implementation of the various functions may require applications from the different service providers, wherein the applications work together to accomplish an overall task. In this instance, assume that one of the secure applications provided to the network agent 18 from the NPS 26 relates to one aspect of implementing DRM from the primary service provider's perspective (step 120). The NPS 26 will then send cryptography information to the network agent 18 (step 122) as well as to the alternate service providers 44 (step 124). The cryptography information may include keys or other encryption seeds, and the alternate service providers 44 may be able to verify the cryptography information (step 126), and as such will acknowledge receipt of the proper cryptography information from the NPS 26 (step 128).

At this point, the network agent 18 and an alternate service provider 44 are able to establish a secure provider link therebetween (step 130). Over the secure provider link, the alternate service provider 44 may download one or more secure applications, including in this example a secure application for implementing DRM as required by the alternate service provider 44 (step 132). Upon receipt of the secure applications, the network agent 18 will send an acknowledgement back to the alternate service provider 44 (step 134). Receipt of the original secure applications may trigger the alternate service provider 44 to provide additional secure applications, including a content tagging application, to the network agent 18 (step 136). The network agent 18 will acknowledge receipt of the additional secure applications (step 138). The content tagging application may cooperate with the DRM applications from the alternate service provider 44 as well as the primary service provider. The content tagging may be used to identify and tag traffic where DRM should be applied. Once identified, the DRM applications are used to process the traffic accordingly.

At this point, assume the customer endpoint 54 initiates a service request for a service to be provided by the alternate service provider (ASP) 44 (step 140). The service request will be received by the customer agent 20 of the customer service gateway 12. The customer agent 20 will process the request and forward it to the network agent 18 (step 142), which will verify that the request is within the policy previously provided by the NPS 26 (step 144). Assuming the request is within the given policy, the network agent 18 will send the service request to the NPS 26 (step 146), which will determine whether the request is authorized. If the request is authorized (step 148), the NPS 26 will forward the service request to the appropriate alternate service provider 44 for authorization and fulfillment (step 150). If the service request is authorized (step 152), acknowledgements may be propagated back through the NPS 26, network agent 18, and customer agent 20 to the customer endpoint 54 (steps 154, 156, 158, and 160).

At this point, the alternate service provider 44 will begin sending content (traffic) for the requested service to the network agent 18 of the customer service gateway 12 (step 162). The network agent 18 will run the primary and alternate service provider applications to implement the respective monitoring, tagging, and DRM functions (step 164). These applications may include monitoring all incoming traffic, identifying traffic associated with the requested service from the alternate service provider 44, recognizing that the traffic requires DRM, and implementing DRM processing for the content of the requested service. The processing may include tagging for subsequent processing at the customer agent 20 or the customer endpoint 54, protocol conversion, compression, decryption, or any other functions deemed necessary and supported by the requisite applications. After processing for the respective applications running on the network agent 18, the content is sent to the customer agent 20 (step 166), which may run the customer applications to implement any functions deemed appropriate at the customer agent 20 (step 168) prior to being sent to the customer endpoint 54 (step 170).

The applications running on the customer agent 20 may be modified or configured by the customer to implement customized functions on the content. Actual applications may be provided via the network agent 18 or directly from the customer or appropriate customer endpoint 54. Tagging may take place at the network agent 18 or at the customer agent 20 for subsequent processing at the customer endpoint 54. When tagging occurs at the network agent 18, subsequent processing may take place at the customer agent 20 as well. Although the above illustration is focused on streaming content requiring DRM from an alternate service provider 44 to the customer endpoint 54, any type of media session may be provided by the primary service provider or the alternate service provider 44, in either direction. For services that may result in traffic moving in either direction, functions afforded by applications at the customer agent 20 and the network agent 18 may be implemented as necessary or desired.

Accordingly, the customer service gateway 12 acts as a policy enforcement point capable of receiving applications from various service providers on how to tag, process, or otherwise control upstream or downstream traffic flows. The customer service gateway 12 provides a trusted service management point on the customer premises for the primary service provider as well as for alternate service providers 44 that have established a relationship with the primary service provider. In addition to various processing functions, the customer service gateway 12 may be used to schedule and steer traffic according to defined policies, and may be used to provide specific billing based on the actual content, services, or quality of experience actually afforded to the customer.

While services are provided, the customer service gateway 12 and the NSE 24 will continue managing the respective packet flows according to the policy parameters. Such management will include classifying traffic flows for the various services that are implemented; providing queuing; maintaining a desired quality of service; shaping, controlling, processing, or filtering the traffic; or preventing unauthorized use of the local access network 16 by other CPEs 10. The customer service gateway 12 and NSE 24 will effectively route all traffic for all services over the appropriate virtual communication pipes according to the defined policy parameters. Traffic for the service may be recognized by checking an identifier or label provided with the packets and associated with the particular service. In a preferred embodiment, the source and destination addresses, and potentially the respective ports used by the CPE 10 and the content server 46, are monitored to identify packets to be processed and transported over the virtual communication pipe in association with the service and according to the policy parameters. Accordingly, differentiated services may be provided over a single local access network 16 in a controlled fashion. With the present invention, the local access network 16 can be effectively partitioned among multiple services in a manner wherein the respective services will not negatively impact the others.

In addition to the above benefits, another embodiment of the present invention allows for differentiated billing for the respective services. Since the services may be established on an individual basis, accounting for these services may also be provided on an individual basis. Various entities illustrated in FIG. 1 may be used to collect accounting information, which will be processed and sent directly or indirectly to the billing server 52. The accounting information may be processed during the service, after the service, or a combination thereof. For example, when a service is terminated, the customer endpoint 54 may send a request to terminate the service, and the NPS 26 will take the necessary steps to remove the service policy and tear down the virtual communication pipe established between the customer service gateway 12 and the NSE 24.

The NPS 26 may send a message to terminate the service policy to the NSE 24, which may then send a message to terminate the service policy to the customer service gateway 12. If billing is based on content, the service provider or network agent 18 may generate billing information and send the billing information to the billing server 52. Alternatively, the NSE 24 may generate the billing information and forward the billing information to the billing server 52. Those skilled in the art will recognize numerous techniques for monitoring the service, accounting for the service, and delivering accounting or billing information to an appropriate billing server 52 to facilitate billing for the provided service.

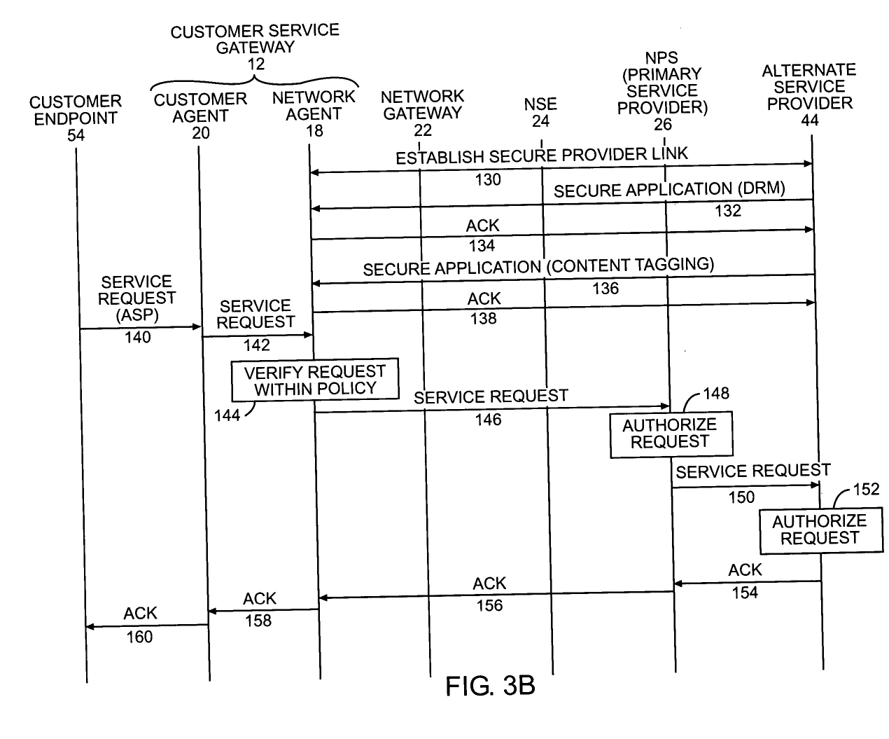

Turning now to FIG. 4, a block representation of a customer service gateway 12 is provided according to a standalone embodiment of the present invention. The customer service gateway 12 may include a control system 56 having memory 58 with sufficient software 60 to implement the customer agent 20 and the network agent 18 as described above. The control system 56 may be associated with one or more local access network interfaces 62 to facilitate communications over the local access network 16. The control system 56 will also be associated with any number of CPE interfaces 64, which are used to interface with the CPEs 10 in direct or indirect fashion. The CPE interfaces 64 may include network, audio, video, and voice interfaces.

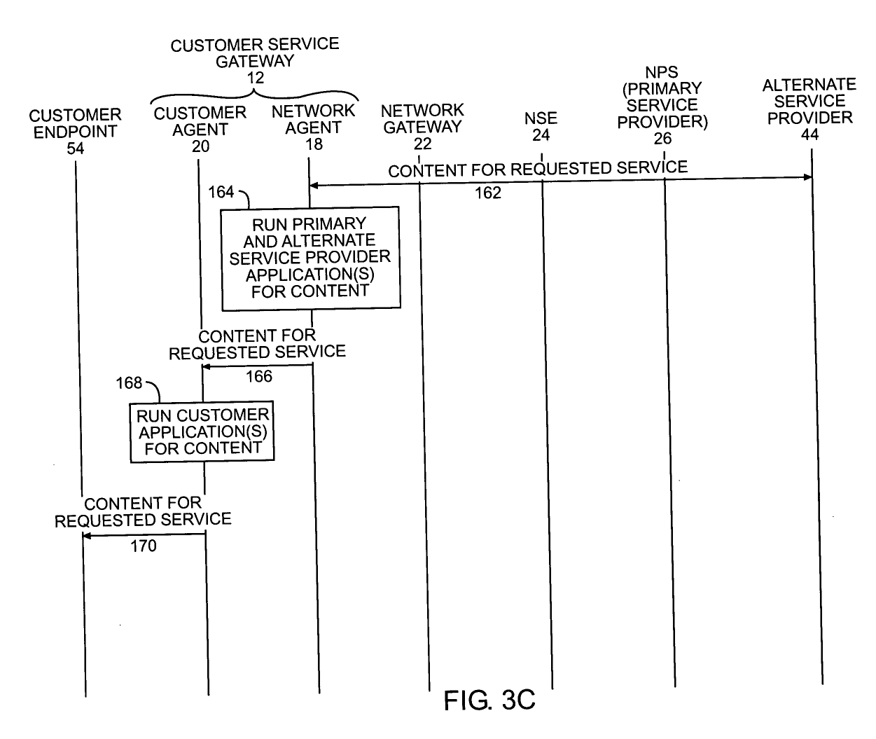

As seen in FIG. 5, the NSE 24 is configured similarly to the customer service gateway 12. The NSE 24 will include a control system 66 having memory 68 with sufficient software 70 to operate as described above. The software 70 will provide a policy enforcement function 72 to establish virtual communication pipes with the customer service gateway 12 over the local access network 16 and control services according to parameters received from the NPS 26. The control system 66 will be associated with one or more communication interfaces 74 to facilitate communications over the local access network 16 directly or indirectly via the network gateway 22, as well as with the NPS 26.

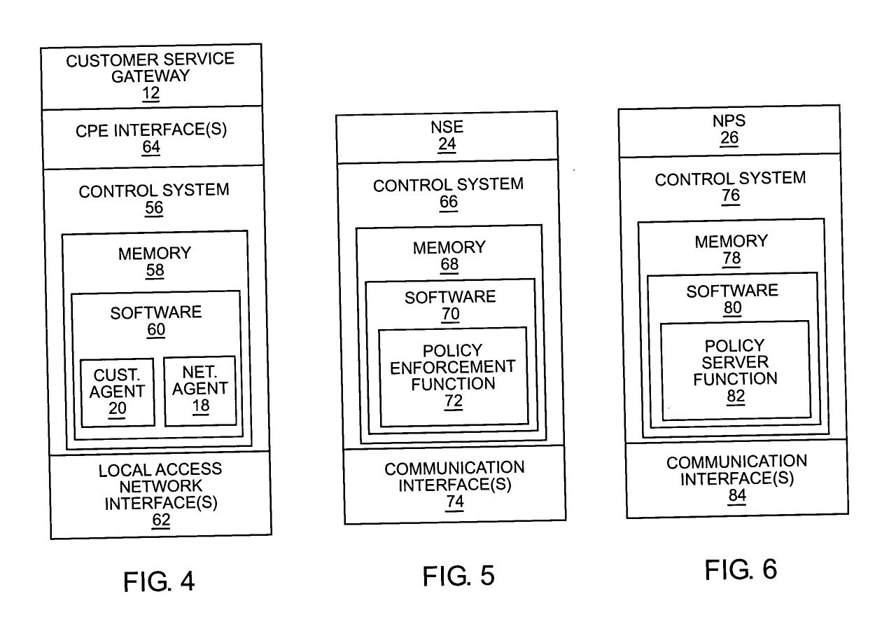

With reference to FIG. 6, the NPS 26 may represent a logical function, but may be implemented in a traditional network server having a control system 76 with memory 78 for software 80 to control the operation as described above. The software 80 will include a policy server function 82, which will act to control the customer service gateway 12 and the NSE 24 to provide and control services over the local access network 16, as well as cooperate with the alternate service providers 44, content servers 46, session controllers, or other entities involved in providing the services. For such communications, the control system 76 is associated with at least one communication interface 84.

Those skilled in the art will recognize improvements and modifications to the preferred embodiments of the present invention. All such improvements and modifications are considered within the scope of the concepts disclosed herein and the claims that follow.

What is claimed is:

1. A customer service gateway comprising:
a customer premise equipment interface;
a local access network interface; and
a control system associated with the customer premise equipment interface and the local access network interface and adapted to provide a customer agent and a network agent, which cooperate with one another to support services between customer premise equipment and at least one service provider, the network agent adapted to provide trusted service management on behalf of the at least one service provider at a customer premise.

2. The customer service gateway of claim 1 wherein the network agent is further adapted to:
receive service provider applications from the at least one service provider; and
run the service provider applications to implement provider functions for the services or service flows associated with the services to provide the trusted service management.

3. The customer service gateway of claim 2 wherein the provider functions control either the services or traffic in the service flows.

4. The customer service gateway of claim 3 wherein the provider functions process the traffic in the service flows.

5. The customer service gateway of claim 3 wherein the provider functions tag the traffic in the service flows for subsequent processing.

6. The customer service gateway of claim 2 wherein the provider functions monitor either the services or the traffic in the service flows.

7. The customer service gateway of claim 1 wherein there is no customer access to the network agent.

8. The customer service gateway of claim 1 wherein the customer agent is further adapted to:
receive customer applications; and
run the customer applications to implement additional functions for the services or service flows associated with the services.

9. The customer service gateway of claim 8 wherein at least one of the customer applications is received from the network agent.

10. The customer service gateway of claim 8 wherein the customer applications at the customer agent are customizable by a customer or the customer premise equipment.

11. The customer service gateway of claim 10 wherein the network agent is further adapted to limit customer customization of at least one of the customer applications.

12. The customer service gateway of claim 1 wherein the network agent is further adapted to receive a service policy for the at least one service provider and establish communications links having defined resources for the services and support the services according to the service policy.

13. The customer service gateway of claim 1 wherein the at least one service provider comprises a plurality of service providers including a primary service provider, the network agent adapted to simultaneously facilitate a plurality of services associated with a plurality of the plurality of service providers.

14. The customer service gateway of claim 13 wherein at least two of the plurality of services are different types of media services.

15. The customer service gateway of claim 1 wherein the customer agent is adapted to support a plurality of different types of the customer premise equipment.

16. The customer service gateway of claim 1 wherein at least one of the services comprises customer monitoring.

17. The customer service gateway of claim 1 wherein implementing the trusted service management provides service flows for the services having a defined quality of service under control of the at least one service provider.

18. The customer service gateway of claim 1 wherein the trusted service management provides digital rights management for the services.

19. The customer service gateway of claim 1 wherein the trusted service management controls streaming media services comprising audio or video.

20. The customer service gateway of claim 1 wherein the trusted service management controls voice services.

21. The customer service gateway of claim 1 wherein the trusted service management controls internet access.

22. A method comprising:
providing a customer premise equipment interface;
providing a local access network interface; and
providing a customer agent and a network agent, which cooperate with one another to support services between customer premise equipment and at least one service provider, the network agent adapted to provide trusted service management on behalf of the at least one service provider at a customer premise.
